(19) United States
(12) Patent Application Publication
(10) Pub. No.: US 2004/0146298 A1
(43) Pub. Date: Jul. 29, 2004

(54) Optical switch

(75) Inventor: Tetsuo Ikegame, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Corporation, Tokyo (JP)

(21) Appl. No.: 10/627,251

(22) Filed: Jul. 24, 2003

(30) Foreign Application Priority Data
Jun. 13, 2002 (JP) 2002-173320

(51) Int. Cl. H04B 14/00

(52) U.S. Cl. 398/45

(57) ABSTRACT

The present invention discloses an optical switch to which one or a plurality of input optical fibers and a plurality of output optical fibers are connected and in which an optical path of light for optical communication emitted from the input optical fiber is switched to a plurality of optical paths through a second galvo unit and a first galvo unit so that the light can be incident on the output optical fibers from which the light should be output. The optical switch includes a light guiding unit for guiding the light to be incident on the output optical fiber to a photo-sensor and a control unit for controlling the angle of the second galvo unit and the angle of the first galvo unit on the basis of detection signal obtained through the light guiding unit.

This application claims benefit of Japanese Application No. 2002-173320 filed in Japan on June 13, the contents of which are incorporated by this reference.

### BACKGROUND OF THE INVENTION

1. Field of the Invention

The present invention relates to optical switches for switching between optical paths used in optical communications or the like and, more particularly, relates to an optical switch for switching an optical path to another optical path, using optical-path switching elements, to allow one light beam for optical communication emitted from one optical fiber used for inputting beams out of one or a plurality of input optical fibers, to be incident on one output optical fiber from which the beams are outputted.

2. Description of Related Art

This kind of conventional optical switches used in optical communications include a device for switching an optical path to another optical path using optical-path switching elements to allow a light beam for optical communication emitted from one or a plurality of intended input optical fibers to be incident on one or a plurality of intended output optical fibers (for example, Japanese Unexamined Patent Application Publication No. 2001-174724).

FIG. 17 is a diagram of the structure of the above-mentioned conventional optical switch. FIG. 18 is a plan view showing an example of a microelectromechanical system (MEMS) mirror array serving as a related art, the array being used in the conventional optical switch.

Referring to FIG. 17, an optical switch 200 comprises input optical fibers 212, input lenses 214, a first MEMS mirror array 218, a second MEMS mirror array 222, output lenses 226, and output optical fibers 228. In this case, to simplify the description, four input optical fibers 212a to 212d and output lenses 228a to 228d are illustrated as the input optical fibers 212 and the output optical fibers 228.

Referring to FIG. 18, tilt mirrors 412, each of which is mounted on a spring 414, are arrayed on a base 416 to form a mirror array 410 constituting the first MEMS mirror array 218 or the second MEMS mirror array 222. Each tilt mirror 412 is controlled by the corresponding electrode (not shown).

The operation of the optical switch 200 having the first MEMS mirror array 218 or the second MEMS mirror array 222 will now be described in brief, each array comprising the above-mentioned mirror array 410.

The optical switch 200 receives optical signals 208 through the input optical fibers 212. The input optical fibers 212 transmit the optical signals 208 to the input lenses 214 serving as collimating lenses. The input lenses 214 form pencil beams 216a to 216d from the optical signals 208. The pencil beams 216a to 216d are formed from the signals carried through the input optical fibers 212a to 212d.

When receiving the beams 216, the first MEMS mirror array 218 reflects the beams in accordance with the tilt angles of respective mirror elements. The reflected beams are selectively aimed to specific mirror elements of the second MEMS mirror array 222. For example, on the basis of the pencil beam 216a, reflected beams 220a to 220a′ are formed. Similarly, for example, on the basis of the pencil beam 216d, reflected beams 220d to 220d′ are formed. These beams are received by mirror elements of the second MEMS mirror array 222. The mirror elements reflect the beams as beams 224 to the output lenses 226. The output optical fibers 228 receive beams converged through the output lenses 226 and transmit the beams as optical signals 229.

In the optical switch 200, each output optical fiber is mapped so as to have a one-to-one correspondence to a mirror of the output mirrors. In this case, a single-mode fiber is required. The reason is as follows: To suppress power loss, an input beam has to match an output beam so that the input and output beams and the optical fiber are coaxial. For this purpose, the numerical aperture of each of the input and output beams required for the matching therebetween is small.

In transmission paths or transmission units used in optical communications, it is important to reduce a loss of the amount of light therein. In other words, it is important to allow beams converged through the output lenses to be incident on the cores of the respective output optical fibers.

In this instance, if the position and inclination of each converged beam relative to the core of the corresponding fiber are deviated, the loss of the amount of light of the beam incident on the output optical fiber increases.

For instance, if there is a difference between the angles of two tilt mirrors disposed between each input optical fiber and the corresponding output optical fiber in the above-mentioned conventional optical switch, each converged beam formed by the output lenses is deviated from the core of the corresponding output fiber with respect to the position and/or the inclination, thus causing a large loss of the amount of light.

According to the above-mentioned conventional optical switch, however, there is no description regarding proper setting of the angle of a mirror serving as an optical-path switching element. A large loss of the amount of light may be caused.

### SUMMARY OF THE INVENTION

It is an object of the present invention to provide an optical switch for appropriately controlling optical-path switching elements to reduce a loss of the amount of light transmitted for communication.

In brief, according to the present invention, there is provided an optical switch including: optical-path switching elements for switching one optical path to another optical path in order to allow one light beam for optical communication emitted from one input optical fiber used for inputting beams out of one or a plurality of input optical fibers, to be incident on one output optical fiber from which beams are outputted out of one or a plurality of output optical fibers; a photo-sensor; a light guiding unit for guiding the beam to be incident on the output optical fiber to the photo-sensor; and a control unit for controlling the angle of the optical-path switching element on the basis of detection signal obtained through the photo-sensor.

According to the present invention, there is provided an optical switch including: optical-path switching elements for switching one optical path to another optical path in order to allow one light beam for optical communication emitted from one input optical fiber used for inputting beams out of one or a plurality of input optical fibers, to be incident on one output optical fiber from which beams are outputted out of one or a plurality of output optical fibers; a photo-sensor; a light guiding unit for guiding the beam to be incident on the output optical fiber to the photo-sensor; and a control unit for adjusting the angle of the optical-path switching element on the basis of detection signal obtained through the photo-sensor to adjust at least one of the relative position and the angle of the beam.

The above and other objects, features and advantages of the invention will become more clearly understood from the following description referring to the accompanying drawings.

### BRIEF DESCRIPTION OF THE DRAWINGS

FIG. 1 is a diagram showing an example of the whole structure of an optical switch for optical communication according to a first embodiment of the present invention;

FIG. 2 is an exploded perspective view of the structure of a second galvo unit used in the optical switch shown in FIG. 1, explaining an example of the structure of the second galvo unit;

FIG. 3 is a sectional view of the second galvo unit in the longitudinal direction, the unit being used in the optical switch shown in FIG. 1;

FIG. 4 is a perspective view of an essential part of the second galvo unit used in the optical switch shown in FIG. 1;

FIG. 5 is a circuit diagram of a processing circuit for processing detection signals supplied from an angle detector element of the second galvo unit used in the optical switch shown in FIG. 1;

FIG. 6 is an exploded perspective view of a first galvo unit used in the optical switch shown in FIG. 1, explaining an example of the structure of the first galvo unit;

FIG. 7 is a sectional view of the first galvo unit taken along the minor axis, the unit being used in the optical switch shown in FIG. 1;

FIG. 8 is a perspective view of an essential part of a galvo array, namely, a photo-sensor, light guiding means, and control means which are used in the optical switch shown in FIG. 1;

FIG. 9 is a block diagram of the control means used in the optical switch shown in FIG. 1, showing an example of the partial structure of the control means;

FIG. 10 is a diagram explaining the operation of the optical switch according to the first embodiment of the present invention;

FIG. 11 is an exploded perspective view of an optical switch according to a second embodiment of the present invention, showing another arrangement of light guiding means and a photo-sensor;

FIG. 12 is a perspective view of the optical switch according to the second embodiment of the present invention, showing the relation between the light guiding means, the photo-sensor, and an output optical fiber;

FIG. 13 is a side plan view of the optical switch according to the second embodiment of the present invention, including a section of the optical switch in which the light guiding means, the photo-sensor, and the output optical fiber are built to each other;

FIG. 14 is a perspective view of an optical switch according to a third embodiment of the present invention, explaining the relation between an output-side lens, light guiding means, a photo-sensor, and the output optical fiber;

FIG. 15 is a diagram of the structure of an optical switch according to a fourth embodiment of the present invention, showing the arrangement of the output-side lens, the output optical fiber, light guiding means, and a photo-sensor;

FIG. 16 is a diagram of the optical switch according to the fourth embodiment of the present invention, explaining detection signals obtained through the photo-sensor and the waveforms thereof, the abscissa axis denoting a position of a detected light beam and the ordinate axis indicating the amplitude of the detection signal;

FIG. 17 is a diagram of the structure of a conventional optical switch; and

FIG. 18 is a plan view of a microelectromechanical system (MEMS) mirror array serving as a related art, the array being used in the conventional optical switch.

### DETAILED DESCRIPTION OF PREFERRED EMBODIMENTS

Embodiments of the present invention will be described hereinbelow with reference to the drawings.

[First Embodiment]

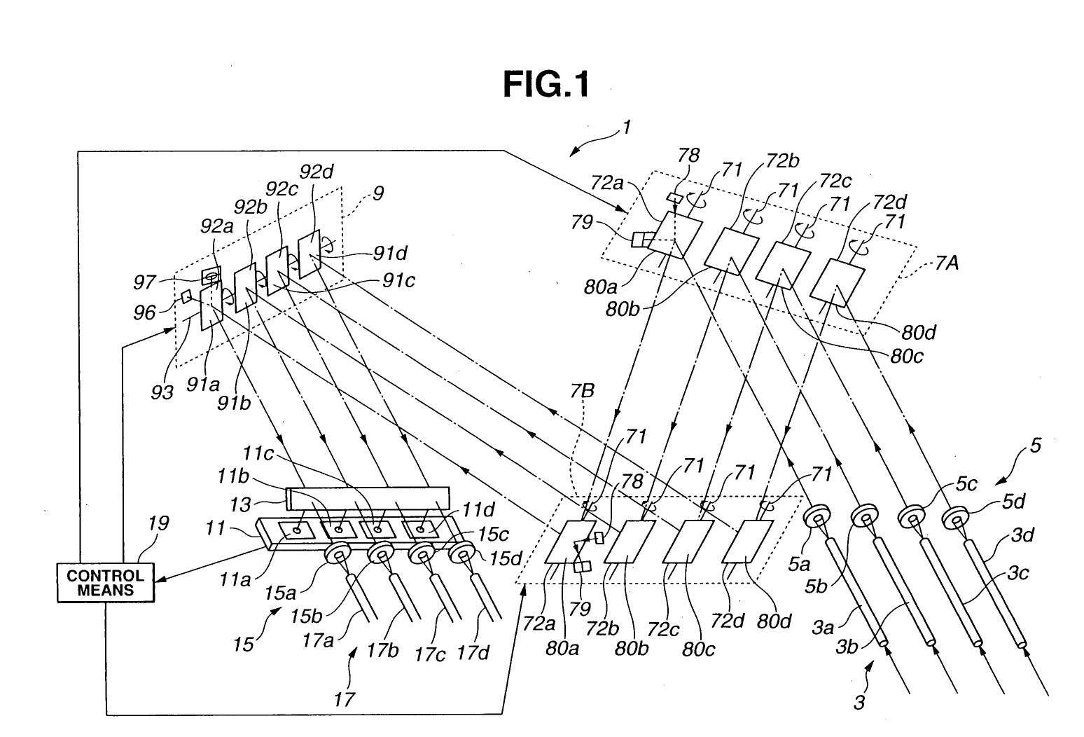

FIGS. 1 to 10 are diagrams explaining an optical switch according to a first embodiment of the present invention.

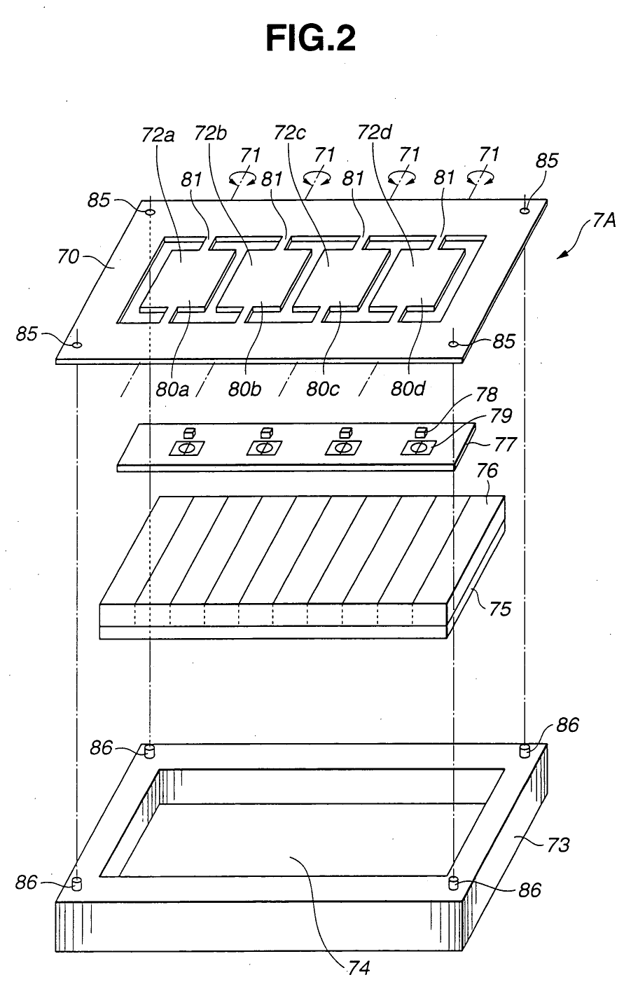

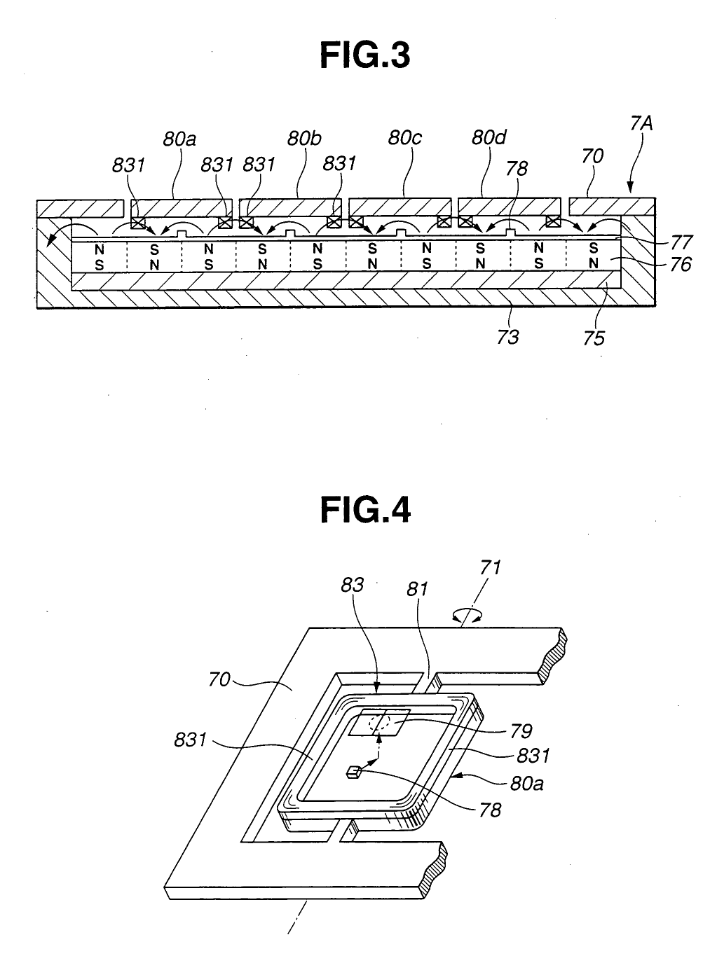

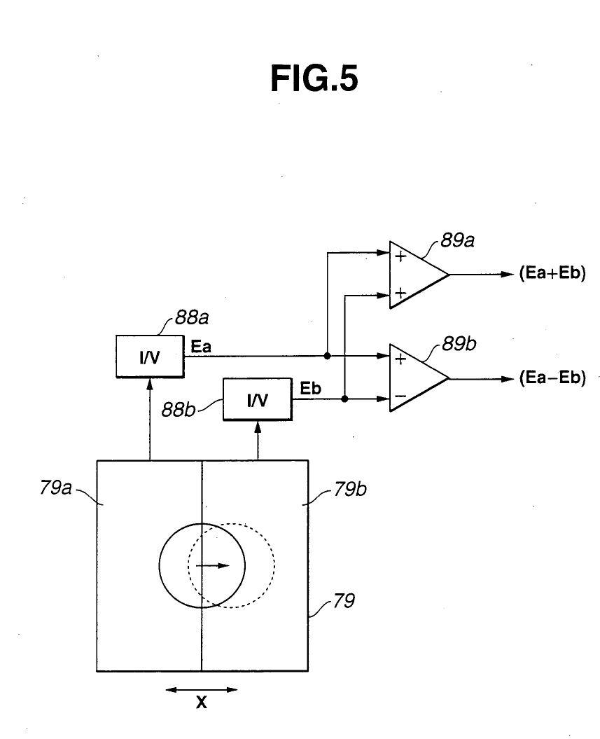

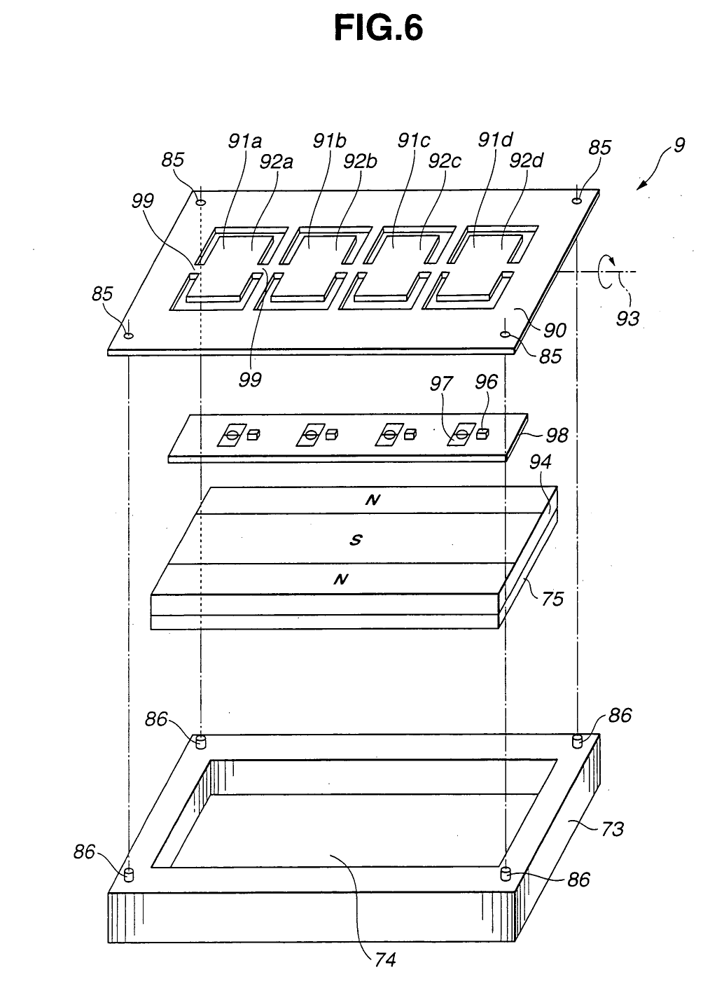

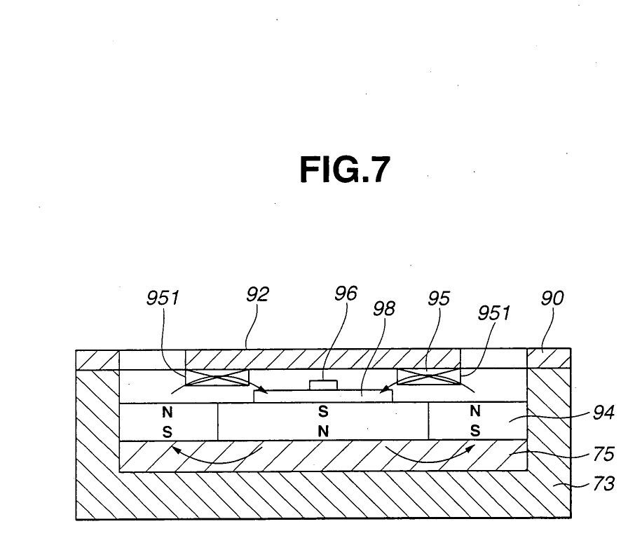

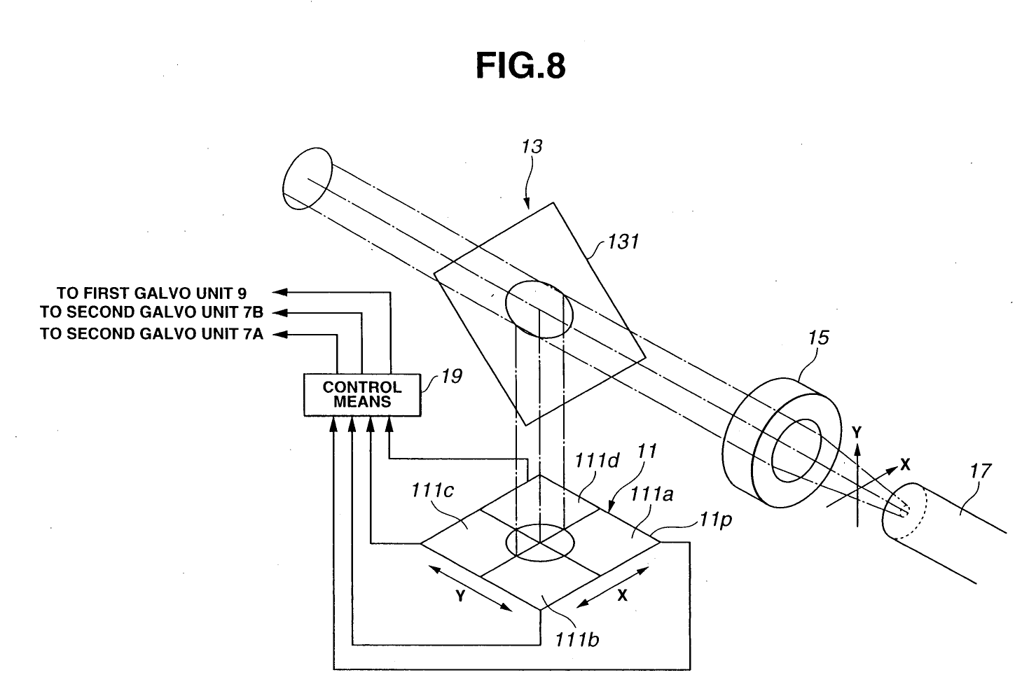

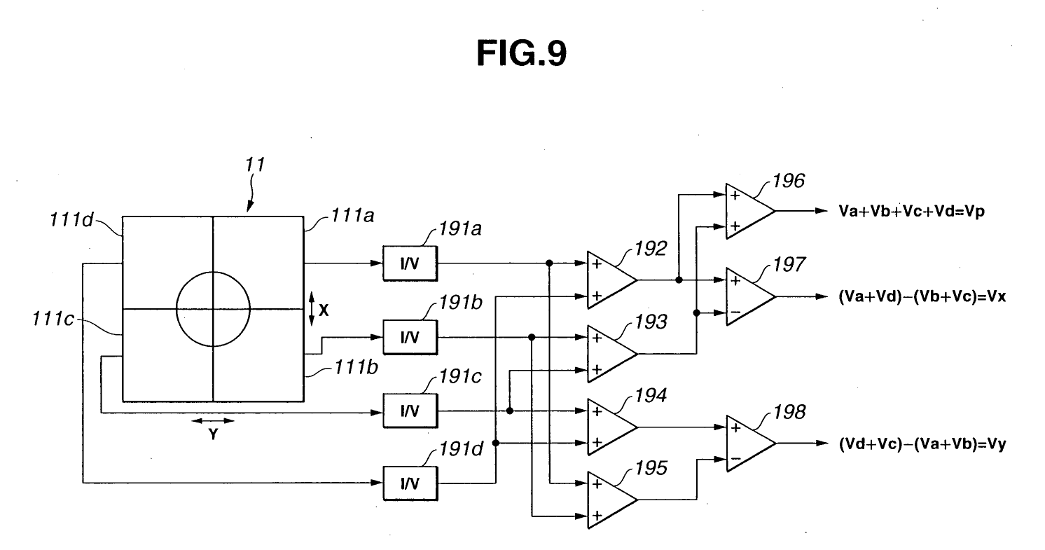

The structure of the optical switch according to the first embodiment of the present invention will now be described. FIG. 1 is a diagram of the whole structure of the optical switch for optical communication according to the first embodiment of the present invention. FIG. 2 is an exploded perspective view of the structure of a second galvo (galvanometer) unit used in the optical switch shown in FIG. 1. FIG. 3 is a sectional view of the second galvo unit in the longitudinal direction, the unit being used in the optical switch shown in FIG. 1. FIG. 4 is a perspective view of an essential part of the second galvo unit used in the optical switch shown in FIG. 1. FIG. 5 is a circuit diagram of a processing circuit for processing detection signals supplied from an angle detector element of the second galvo unit used in the optical switch shown in FIG. 1. FIG. 6 is an exploded perspective view of the structure of a first galvo unit used in the optical switch shown in FIG. 1. FIG. 7 is a sectional view of the first galvo unit taken along the minor axis, the unit being used in the optical switch shown in FIG. 1. FIG. 8 is a perspective view of an essential part of a galvo array, namely, a photo-sensor, light guiding means, and control means which are used in the optical switch shown in FIG. 1. FIG. 9 is a block diagram of the partial structure of the control means used in the optical switch shown in FIG. 1.

(Whole Structure of Optical Switch 1)

The whole structure of the optical switch according to the first embodiment of the present invention as an example will now be described with reference to FIG. 1.

Referring to FIG. 1, according to the first embodiment of the present invention, an optical switch 1 broadly comprises: one or a plurality of input optical fibers 3 fixed to the switch body; input-side lenses 5 which are disposed in a stage subsequent to the input optical fibers 3 and each of which collimates a light beam emitted from the corresponding input optical fiber 3; two second galvo units 7A and 7B arranged in a stage subsequent to the input-side lenses 5, each unit serving as an optical-path switching element; a first galvo unit 9 disposed in a stage subsequent to the second galvo unit 7B, the unit 9 being used to change optical paths; light guiding means 13 arranged in a stage subsequent to the first galvo unit 9, the means 13 partially guiding beams for communication to a photo-sensor 11; output-side lenses 15 disposed in a stage subsequent to the light guiding means 13, each lens 15 converging an incident beam for communication passing through the light guiding means 13; a plurality of output optical fibers 17 for receiving beams for communication converged through the output-side lenses 15, respectively; the photo-sensor 11 for receiving beams guided through the light guiding means 13 to output detection signals; and control means 19 which can control the angle of each optical-path switching element on the basis of the detection signals supplied from the photo-sensor 11.

Preferably, the light guiding means 13 is arranged in the stage subsequent to the first galvo unit 9 and is disposed just before the output-side lenses 15. The light guiding means 13 can also be arranged in a stage subsequent to the second galvo unit 7A or 7B serving as the optical-path switching element. It is essential only that the photo-sensor 11 effectively detects the inclination or position of a beam output from at least one optical-path switching element (the second galvo unit 7A or 7B).

Components will now be further described. In this instance, to simplify the following description, it is assumed that the optical switch 1 according to the first embodiment of the present invention is constructed as a 2×2 optical switch comprising two input channels and two output channels. The description will now be made with respect to the above optical switch as an example. It is assumed that two optical paths of two optical signals among optical signals emitted from four input optical fibers are selectively switched to other paths using two of four output optical fibers.

In the optical switch 1 according to the first embodiment of the present invention, to simplify the description, it is assumed that four optical fibers 3a to 3d are used as the input optical fibers 3, four optical fibers 17a to 17d are used as the output optical fibers 17, and optical paths up to the output optical fibers 17a to. 17d are arranged in parallel to the input optical fibers 3a and 3d.

In accordance with the above arrangement, the input-side lenses 5 include input-side lenses 5a to 5d and the output-side lenses 15 include output-side lenses 15a to 15d.

The description will be provided on the assumption that the first galvo unit 9 includes galvanometer mirrors 92a to 92d with four mirror surfaces 91, the mirrors 92a to 92d being arrayed. The structure of the first galvo unit will be described later.

Similarly, the description will be provided on the assumption that each of the second galvo units 7A and 7B includes four galvanometer mirrors 72a to 72d arrayed.

Since only two optical paths exist as mentioned above, each of the first galvo unit 9 and the second galvo units 7A and 7B can essentially include two galvanometer mirrors. According to the present embodiment, the first galvo unit 9 and the second galvo units 7A and 7B each have four galvanometer mirrors as mentioned above. Accordingly, in each of the first galvo unit 9 and the second galvo units 7A and 7B, since the number of galvanometer mirrors required is doubled, it is enough.

The photo-sensor 11 comprises photo-sensor elements 11a to 11d corresponding to the respective channels.

The components constituting the above-mentioned optical switch 1 will now be described in detail with reference to the drawings.

(Structure of Second Galvo Unit 7A or 7B)

The structure of the second galvo unit 7A or 7B will now be described with reference to FIGS. 2 to 4. According to the first embodiment, exactly the same units are used as the second galvo units 7A and 7B. Therefore, only the second galvo unit 7A will now be described. The explanation regarding the second galvo unit 7B is omitted.

The second galvo unit 7A comprises a mirror plate 70 and the four galvanometer mirrors 72a to 72d which are rotatably about the respective rotation axes 71 and are arranged in series perpendicular to the rotation axes 71. The four galvanometer mirrors 72a to 72d are arrayed. Referring to FIGS. 2 and 3, in the second galvo unit 7A, a yoke 75 is received and fixed into a holding portion 74 of a box housing 73, the yoke 75 being slightly smaller than the plane area of the holding portion 74. A magnet 76 is fixed on the upper surface of the yoke 75 as shown in FIGS. 2 and 3. A tilt-angle detector unit 77 is fixed on the magnet 76 as shown in FIGS. 2 and 3. The major length of the tilt-angle detector unit 77 is substantially the same as that of the holding portion 74. The minor length of the tilt-angle detector unit 77 is fairly shorter than that of the holding portion 74. The tilt-angle detector unit 77 comprises a base made of polyimide, aluminum, silicon, or ceramic, light-emitting diodes (LED) 78, and photodiodes (PD) 79 each having a light receiving surface which is divided as shown in FIG. 4. The LEDs 78 and PDs 79 are fixed on the base at predetermined intervals, each LED 78 and the corresponding PD 79 constituting one unit. The respective units are arranged so as to correspond to the four galvanometer mirrors 72a to 72d. The galvanometer mirrors 72a to 72d are disposed so as to face the magnet 76. Further, the galvanometer mirrors 72a to 72d can be tilt (rotated) about the rotation axes 71 with respect to the mirror plate 70. Accordingly, four mirror surfaces 80a to 80d each serving as a rotatable portion can be tilt.

The four mirror surfaces 80a to 80d are formed by etching the mirror plate 70 serving as a thin plate of stainless steel, gallium arsenide polysilicon, or monocrystalline silicon in a shape shown in FIGS. 3 and 4. In this case, each of the square or rectangular thin plates constituting the mirror surfaces 80a to 80d is etched so as to leave linear portions at the respective centers (corresponding to the rotation axis 71) of the upper and lower sides in the lateral direction. Thus, the linear portions function as springs 81, respectively. Consequently, the mirror surfaces 80a to 80d are elastically, rotatably, and deformably connected and supported.

The mirror surfaces 80a to 80d are supported by the rotation axes 71 serving as central axes along the respective springs 81. A coating film comprising, for example, gold or a dielectric multilayer film is formed on the surface serving as a reflecting surface of each of the mirror surfaces 80a to 80d, thus increasing reflectivity. A thin coating film made of polyimide is formed on the rear of the reflecting surface of each of the mirror surfaces 80a to 80d so as not to cover the respective central portions therewith. The thin coating film functions as an insulating layer. Referring to FIG. 4, each coil 83 is further formed by electroforming or etching.

The mirror plate 70 is shaped into a rectangle. Positioning holes 85 are formed at four corners of the plate 70. Pins 86 arranged at four corners on the upper surface of a frame of the housing 73 are fitted into the respective positioning holes 85 serving as references, thus positioning and fixing the mirror plate 70 on the housing 73.

Referring to FIG. 3, the magnet 76 is received and fixed in the housing 73 below the respective mirror surfaces 80a to 80d, the magnet 76 being magnetized with ten poles arranged in parallel to the mirror surfaces 80a to 80d and attached to the yoke 75.

As shown in FIG. 3, the coils 83 are disposed so that the effective sides 831 thereof are positioned on the boundaries between the poles of the magnet 76. Consequently, the magnetic field acting on the effective sides 831 of the coils 83 is formed substantially in the horizontal direction as shown in FIG. 3. Accordingly, when a current is supplied to the coils 83, the direction of the current flowing through the effective side 831 of each coil 83 is opposite to that of the current flowing through the other effective side 831 thereof, thus generating torque to allow the mirror surfaces 80a to 80d about the respective rotation axes 71. A magnetic flux generating between the adjacent poles commonly acts on the two coils 83 of the adjacent mirror surfaces of the mirror surfaces 80a to 80d.

The tilt-angle detector unit 77 will now be described. One LED 78 and one PD 79 are used in a pair. The tilt-angle detector unit 77 comprising four pairs of LEDs 78 and PDs 79 is disposed so that the respective pairs (detector elements) correspond to the four mirror surfaces 80a to 80d and each element is disposed within each coil 83. FIG. 4 shows one pair. A light beam obliquely emitted from the LED 78 is reflected by the rear surface of the mirror surface 80a (each of the mirror surfaces 80a to 80d) and is then incident on the corresponding PD 79. Therefore, when the mirror surface 80a (each of the mirror surfaces 80a to 80d) is tilted about the rotation axis 71, the light beam emitted from the LED 78 shifts perpendicular to a parting line of the PD 79.

A processing circuit for processing detection signals supplied from the angle detector element of the second galvo unit used in the optical switch 1 shown in FIG. 1 will now be described with reference to FIG. 5.

Referring to FIG. 5, the processing circuit comprises: a current-voltage converting circuit 88a for capturing and converting a detection signal supplied from a PD 79a of the PD 79 into a voltage, a current-voltage converting circuit 88b for capturing and converting a detection signal generated from a PD 79b into a voltage, the PDa and PDb obtained by dividing the PD 79 into two segments; an adding circuit 89a for summing output voltages Ea and Eb supplied from the current-voltage converting circuits 88a and 88b; and a subtracting circuit 89b for obtaining a difference between the output voltages Ea and Eb supplied from the current-voltage converting circuits 88a and 88b. The adding circuit 89a can provide an addition output (Ea+Eb). The subtracting circuit 89b can provide a subtraction output (Ea−Eb). On the basis of the addition output and the subtraction output, X=(Ea−Ed)/(Ea+Ed) is calculated. Thus, an angle signal normalized on the basis of the amount of light is obtained. The inclination of each of the mirror surfaces 80a to 80d can be detected using the normalized angle signal.

As mentioned above, the second galvo unit 7A has the four mirror surfaces 80a to 80d integrated within the housing 73.

(Structure of First Galvo Unit 9)

The structure of the first galvo unit 9 will now be described with reference to FIGS. 6 and 7.

As shown in FIGS. 6 and 7, the first galvo unit 9 is constructed substantially similar to the second galvo unit 7A. The first and second galvo units 9 and 7A are quite different from each other with respect to the following points. First, four galvanometer mirrors 92a to 92d having mirror surfaces 91a to 91d, respectively, (reference numeral “92” corresponds to reference numerals 92a to 92d in FIG. 7) can be tilt (rotated) about an axis 93 parallel to the longitudinal direction of the first galvo unit 9 (the direction of arrangement of the galvanometer mirrors 92a to 92d). Second, a magnet 94 is magnetized with three poles on each surface, the poles being parallel to the axis 93. Third, referring to FIG. 7, a magnetic flux in the horizontal direction acts on both effective sides 951 of a coil 95. Fourth, a tilt-angle detector unit 98 comprising four pairs of LEDs 96 and PDs 97 is disposed. Each LED 96 and the corresponding PD 97 used in a pair are arranged along the axis 93. In order to effectively detect the angles of the respective mirror surfaces 91a to 91d, the four pairs are arranged. Reference numeral 90 denotes a mirror plate and reference numeral 99 denotes a spring. In the first galvo unit 9, the above-mentioned components are different from those of the second galvo unit 7A and the other components are substantially the same as those of the second galvo unit 7A. The same reference numerals are assigned to the same components to omit the description. As mentioned above, the first galvo unit 9 also has the four mirror surfaces 91a to 91d integrated within the housing 73.

(Structures of Light guiding means 13, Photo-sensor 11, Output-side Lens 15, and Output Optical Fiber 17)

The structures of the portion including the light guiding means 13, the photo-sensor 11, the output-side lens 15, and the output optical fiber 17 will now be described with reference to FIG. 8, FIG. 8 showing one channel.

First, the light guiding means 13 and the photo-sensor 11 will now be described.

The light guiding means 13 comprises a beam splitter 131. The beam splitter 131 is disposed in a stage subsequent to the first galvo unit 9 and is located on a path of a light beam for optical communication just before the output-side lens 15. The beam splitter 131 partially splits the beam for optical communication and then guides the split beam to the photo-sensor 11. The beam splitter 131 partially reflects a collimated beam for optical communication (about 1 to 20 [%] of the total amount of beam for optical communication) and then guides the reflected beam to the photo-sensor 11.

The photo-sensor 11 will now be described. The photo-sensor 11 comprises an indium gallium arsenide (InGaAs) base plate with high sensitivity to light having a wavelength of 1.3 to 1.6 [μm]. Referring to FIG. 8, a PD light receiving surface formed on a plate lip using a photodiode is divided into four segments to construct the photo-sensor 11. The photo-sensor 11 captures the beam incident on the PD light receiving surfaces 111a to 111d and then converts the beam into four electric signals. Thus, the photo-sensor 11 can detect the position of the beam in two directions (X and Y axes). The electric signals obtained through the PD light receiving surfaces 111a to 111d of the photo-sensor 11 are input to the control means 19.

Further, the output-side lens 15 will now be described. The output-side lens 15 is arranged in a stage subsequent to the light guiding means 13 to converge the collimated beam for optical communication to be incident on the output-side lens 15 so as to allow the beam to enter the core of the output optical fiber 17.

In addition, the output optical fiber 17 will now be described. The output optical fiber 17 transmits a beam for optical communication converged through the output-side lens 15.

(Structure of Control Means 19)

The structure of the control means 19 will now be described with reference to FIG. 9. The control means 19 comprises current-voltage converting circuits 191a to 191d for capturing detection signals supplied from the PD light receiving surfaces 111a to 111d of the photo-sensor 11, respectively, and then converting the signals into voltage signals, an adding circuit 192 for adding output voltages Va and Vd supplied from the current-voltage converting circuits 191a and 191d, an adding circuit 193 for adding output voltages Vb and Vc supplied from the current-voltage converting circuits 191b and 191c, an adding circuit 194 for adding output voltages Vc and Vd supplied from the current-voltage converting circuits 191c and 191d, an adding circuit 195 for adding output voltages Va and Vb supplied from the current-voltage converting circuits 191a and 191b, an adding circuit 196 for adding output signals generated from the adding circuits 192 and 193, a subtracting circuit 197 for subtracting the output signal of the adding circuit 193 from the output signal of the adding circuit 192, a subtracting circuit 198 for subtracting an output signal of the adding circuit 195 from an output signal of the adding circuit 194, and a processing circuit (not shown) for generating a control signal from those detection signals.

Output currents supplied from the PD light receiving surfaces 111a to 111d of the photo-sensor 11 are converted into the voltage signals Va to Vd by the current-voltage converting circuits 191a to 191d, respectively. On the basis of the voltage signals Va to Vd obtained through the current-voltage converting circuits 191a to 191d, the adding circuit 192 to subtracting circuit 198 obtain differentials in the X and Y axial directions between outputs generated from the PD light receiving surfaces 111a to 111d as four areas. Thus, the position of a beam in two directions (X and Y axes) perpendicular to the optical axis of the output-side lens 15 can be detected.

In other words, an output voltage Vx obtained through the subtracting circuit 197 is given by {(Va+Vd)−(Vb+Vc)}. An output voltage Vy obtained through the subtracting circuit 198 is given by {(Vc+Vd)−(Va+Vb)}. Further, an output voltage Vp obtained through the adding circuit 196 is given by (Va+Vb+Vc+Vd). On the basis of the output voltages Vx, Vy, and Vp, calculation is performed as shown by the following expressions 1 and 2, thus obtaining the normalized position of the beam for optical communication with respect to the output-side lens 15 in two directions (X and Y axes) perpendicular to the optical axis of the output-side lens 15.

$$\begin{matrix}X = Vx / Vp & [ Expression 1 ] \\ = \{ ( Va + Vd ) - ( Vb + Vc ) \} / ( Va + Vb + Vc + Vd ) & \\ Y = Vy / Vp & [ Expression 2 ] \\ = \{ ( Vc + Vd ) - ( Va + Vb ) \} / ( Va + Vb + Vc + Vd ) & \end{matrix}$$

On the basis of information regarding the X and Y axial directions obtained as mentioned above, a signal responsive to the position and/or inclination of the beam spot, converged through the output-side lens 15, relative to the core of the output optical fiber 17 can be obtained.

(Operation of Optical Switch 100)

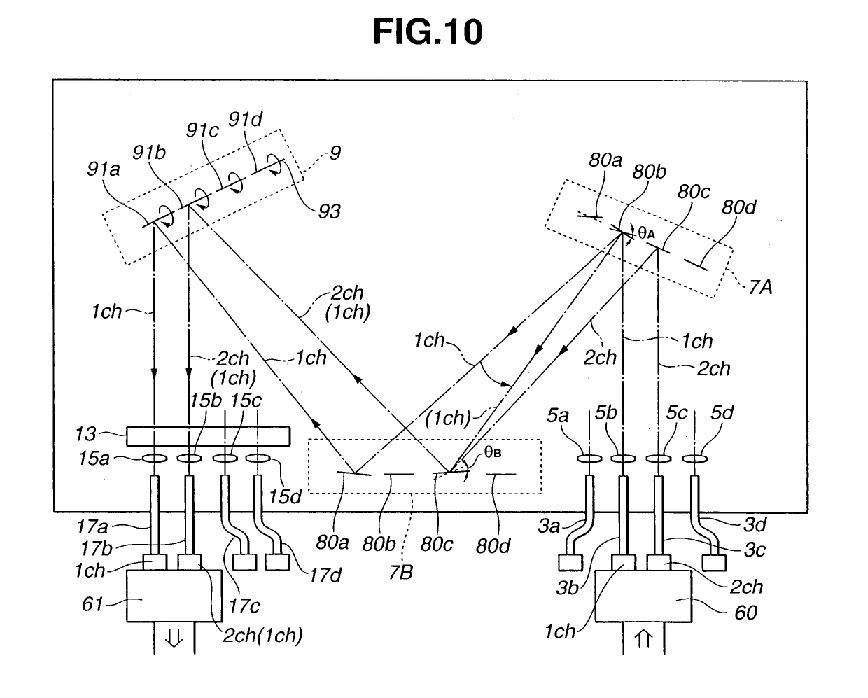

The operation of the optical switch 100 constructed as mentioned above will now be described on the basis of FIGS. 1 to 9 with reference to FIG. 10. FIG. 10 is a diagram explaining the operation of the optical switch according to the first embodiment of the present invention.

According to the first embodiment of the present invention, the optical switch 1 serves as a device for switching optical signals between two input channels and two output channels as mentioned above. It is assumed that two galvanometer mirrors, for example, 91c and 91d of the four galvanometer mirrors 91a to 91d constituting the first galvo unit 9 cannot be used because they are defective in a stage of manufacture, and the other two galvanometer mirrors 91a and 91b are available. Similarly, it is assumed that one mirror surface 80a of the second galvo unit 7A is defective and the other three mirror surfaces 80b to 80d are available. Further, it is assumed that the two mirror surfaces 80b and 80d of the second galvo unit 7B are defective and the other two mirror surfaces 80a and 80c are available. Therefore, the first galvo unit 9 and the second galvo units 7A and 7B each have two available galvanometer mirrors.

The input optical fiber 3b is fixed to a first channel (1ch) of an input box 60 of the optical switch 1. The input optical fiber 3c is fixed to a second channel (2ch) of the input box 60 of the optical switch 1. Connectors for input fibers are connected to the input box 60.

The output optical fiber 17a is fixed to a first channel (1ch) of an output box 61 of the optical switch 1. The output optical fiber 17b is fixed to a second channel (2ch) of the output box 61 of the optical switch 1. Connectors for output fibers are connected to the output box 61.

As a standard optical path of a beam entering the first channel of the output box 61 of the optical switch 1, the beam passes along an optical path including the input optical fiber 3b, the input-side lens 5b, the mirror surface 80b of the galvanometer mirror 72b of the second galvo unit 7A, the mirror surface 80a of the galvanometer mirror 72a of the second galvo unit 7B, the mirror surface 91a of the galvanometer mirror 92a of the first galvo unit 9, the light guiding means (beam splitter) 13, the output-side lens 15a, the output optical fiber 17a, and the first channel of the output box 61 of the optical switch 1.

As a standard optical path of a beam entering the second channel of the output box 61 of the optical switch 1, the beam passes along an optical path including the input optical fiber 3c, the input-side lens 5c, the mirror surface 80c of the galvanometer mirror 72c of the second galvo unit 7B, the mirror surface 80c of the galvanometer mirror 72c of the second galvo unit 7B, the mirror surface 91b of the galvanometer mirror 92b of the first galvo unit 9, the light guiding means (beam splitter) 13, the output-side lens 15b, the output optical fiber 17b, and the second channel of the output box 61 of the optical switch 1.

Under the above-mentioned precondition, the operation of the optical switch 1 will now be described in a concrete manner.

In an initial state, in order to allow the beams passing through the input optical fibers 3b and 3c to be incident on the output optical fibers 17a and 17b, respectively, the mirrors 80b and 80c of the second galvo unit 7A, the two mirrors 80a and 80c of the second galvo unit 7B, and the two mirror surfaces 91a and 91b of the first galvo unit 9 are controlled in the following manner.

In other words, in each of the second galvo units 7A and 7B, in the tilt-angle detector unit 77, signals are obtained through the angle detector element corresponding to the galvanometer mirror 72, the element comprising the LED 78 and the PD 79. The obtained signals are supplied to the current-voltage converting circuits 88a and 88b corresponding to the galvanometer mirror 72. As shown in FIG. 5, a current is supplied to the coil 83 arranged on the rear surface of the galvanometer mirror 72 so that a differential output (Ea−Eb), generated from the subtracting circuit 89b for performing subtraction involving the outputs of the current-voltage converting circuits 88a and 88b corresponding to the galvanometer mirror 72, indicates a differential output corresponding to a predetermined angle of the mirror surface, the differential output being included in a previously set table indicating the relationship between differential outputs and mirror angles. Thus, the galvanometer mirror 72 is held at the predetermined angle.

The first channel on the input side will now be described. When a light beam for communication is emitted from the input optical fiber 3b, control currents are supplied to the coil 83 of the galvanometer mirror 72b of the second galvo unit 7A, the coil 83 of the galvanometer mirror 72a of the second galvo unit 7B, and the coil 95 of the galvanometer mirror 92a of the first galvo unit 9 so that the position of the beam in the X and Y axes on the PD light receiving surfaces 111a to 111d of the photo-sensor 11 is set to the best position stored, thus fine adjusting the respective angles of the galvanometer mirror 72b of the second galvo unit 7A, the galvanometer mirror 72a of the second galvo unit 7B, and the galvanometer mirror 92a of the first galvo unit 9. In the fine adjustment of the respective angles, the stored best position is set to a reference value and detection signals generated from the tilt-angle detector units 77 and 98 are used as feedback signals to perform feedback control to the angles of the galvanometer mirrors 72 and 92. A light beam for optical communication passing through the second channel is also controlled similar to the above case.

(Explanation Regarding Channel Switching)

The operation to switch the output of the beam emitted from the input optical fiber 3b of the first channel of the input box from the output optical fiber 17a to the output optical fiber 17b will now be described.

It is assumed that an instruction to switch an optical path to another path so that a beam emitted from the first channel on the input side is generated from the second channel on the output side. A reference value to set the galvanometer mirror 72b of the second galvo unit 7A at a predetermined angle θA is supplied to a galvanometer mirror control system (not shown). Then, the galvanometer mirror control system uses output signals, generated from the angle detector element comprising the LED 78 and the PD 79 on the tilt-angle detector unit 77, as feedback signals and supplies a current to the coil 83 so that the angle of the galvanometer mirror matches the reference value, thus tilting the galvanometer mirror 72b of the second galvo unit 7A.

Similarly, a reference value to set the galvanometer mirror 72c of the second galvo unit 7B at a predetermined angle θB is supplied to the galvanometer mirror control system (not shown). Then, the galvanometer mirror control system uses output signals, generated from the angle detector element comprising the LED 78 and the PD 79 on the tilt-angle detector unit 77, as feedback signals and supplies a current to the coil 83 so that the angle of the galvanometer mirror matches the reference value, thus tilting the galvanometer mirror 72c of the second galvo unit 7B.

Consequently, the light beam reflected by the mirror 80b of the second galvo unit 7A is aimed to the mirror 80c of the second galvo unit 7B. The beam reflected by the mirror 80c of the second galvo unit 7B is aimed to the mirror surface 91b of the first galvo unit 9.

In this instance, the beam generated from the input optical fiber 3b is incident on the photo-sensor element 11B. Detection signals obtained through the photo-sensor element 11B are supplied to the control means 19. Thus, the control means 19 performs the following control. In other words, the control means 19 supplies currents to the respective coils 83 of the second galvo units 7A and 7B and the coil 95 of the galvanometer mirror 92 of the first galvo unit 9 so that values indicating the position in the X and Y axes obtained through the photo-sensor element 11B correspond to the optimum values stored, thus fine adjusting the angles of the galvanometer mirrors 72a and 92. To keep the respective angles of the galvanometer mirrors 72 and 92 in this state, the above-mentioned galvanometer mirror control system (not shown) controls the respective mirrors so as to keep outputs of the angle detector elements provided for the respective mirrors.

Consequently, the output optical fiber 17a is switched to the output optical fiber 17b, so that the beam which has been emitted from the first channel of the output box 61 is output from the second channel of the output box 61.

When the optical path of the beam emitted from the second channel of the output box 61 is switched to another optical path so that the beam is emitted from the first channel of the output box 61, switching can be performed in a manner similar to the above case.

As mentioned above, the 2×2 optical switch 1 can be constructed using a plurality of galvo units (for example, the second galvo units 7A and 7B and the first galvo unit 9), the former galvo units each including a plurality of beam switching elements comprising the galvanometer mirrors 72a to 72b and the latter galvo unit having a plurality of beam switching elements comprising the galvanometer mirrors 92a to 92d.

(Consideration)

The second galvo units 7A and 7B or the first galvo unit 9 will now be considered. While the second galvo unit 7A will be considered as a representative galvo unit, the other second galvo unit 7B and the first galvo unit 9 can also be considered.

For instance, the second galvo unit 7A has the four galvanometer mirrors 72a to 72d simultaneously formed. The galvanometer mirrors 72a to 72d may be defective due to the poorly-etched spring 81, a damage on the coat applied to the surface of any of the mirrors 80a to 80d, or the disconnected coil 83. If two galvanometer mirrors of the four galvanometer mirrors are non-defective products, the second galvo unit 7A is available.

On the other hand, in producing the second galvo unit having only two galvanometer mirrors, both the two galvanometer mirrors have to be non-defective products.

The percentage of non-defective galvo units was simulated with respect to a case where each galvo unit has no reserve mirror (each unit has two array galvanometer mirrors and uses both the mirrors), another case where each galvo unit has one reserve mirror (each unit has three array galvanometer mirrors and uses two of them), and still another case where each galvo unit has two reserve mirrors (each unit has four array galvanometer mirrors and uses two of them: this case being the same as the first embodiment of the present invention). It was assumed that the yield of one galvanometer mirror was, for example, 90[%] and 1000 galvo units were manufactured. As a result, the percentage in the case where each unit has no reserve was 80.4[%], that in the case where each unit has one reserve was 98.1[%], and that in the case where each unit has two reserves was 99.8[%].

As understood from the result of this simulation, when two reserves are provided, the percentage of non-defective units of each of the galvo units 7A, 7B, and 9 increases. Therefore, when the yield of one galvanometer mirror is lower than 90[%], the difference between the percentage of non-defective in the case where each unit has no reserve and that in the case where each unit has at least one reserve further increases.

In consideration of the number of galvanometer mirrors simultaneously formed and assembled into an array, the yield of one galvanometer mirror, and the costs of parts, the optimum number of reserve galvanometer mirrors can be determined so that, for example, the minimum cost is obtained.

(Advantages of First Embodiment of the Invention)

As mentioned above, in the optical switch 1 according to the first embodiment of the present invention, the light guiding means (beam splitter) 13 splits a beam transmitted to the stage before the output-side lens 15 through which the beam for optical communication is focused on the output optical fiber 17, the split beam is allowed to be incident on the photo-sensor 11 having the four-divided PD light receiving surfaces 111a to 111d, and the position of the beam in two directions, namely, the X and Y axes is detected on the basis of the outputs of the PD light receiving surfaces 111a to 111d. Consequently, the position and/or tilt error of a beam incident on the output optical fiber 17 can be adjusted. The position of the beam incident on the output optical fiber 17 can be controlled, resulting in a reduction in loss of the amount of beam incident on the output optical fiber 17.

According to the first embodiment of the present invention, the optical switch 1 has at least two or more reserved galvanometer mirrors 72 and 92. Thus, the yield of each of the second galvo units 7A and 7B and the first galvo unit 9 can be remarkably increased.

In the optical switch 1 according to the first embodiment of the present invention, one magnet 76 is shared between the galvanometer mirrors 72a to 72d and one magnet 94 is shared between the galvanometer mirrors 92a to 92d to drive the respective galvanometer mirrors. Accordingly, the number of components is small. Thus, the components can be assembled into the optical switch 1 with high efficiency.

Further, in the optical switch 1 according to the first embodiment of the present invention, the magnet 76 is disposed in parallel to the reflecting surfaces of the galvanometer mirrors 72a to the 72d and the magnet 94 is arranged in parallel to the reflecting surfaces of the galvanometer mirrors 92a to 92d. The galvanometer mirrors 72a to 72d, the magnet 76, the tilt-angle detector unit 77, and the housing 73 (the galvanometer mirrors 92a to 92d, the magnet 94, the tilt-angle detector unit 98, and the housing 73) are laminated in one direction. Thus, the components can be easily assembled into the optical switch 1.

In the optical switch 1 according to the first embodiment of the present invention, the LEDs and the PDs constituting the tilt-angle detector unit 77 (or the tilt-angle detector unit 98) are arranged so that each detector element comprising the LED and the PD is disposed in the space formed within each coil 83 (or the coil 95). Although the tilt-angle detector unit 77 (or the tilt-angle detector unit 98) is disposed between the galvanometer mirrors 72a to 72d (or the galvanometer mirrors 92a to 92d) and the magnet 76 (or the magnet 94), a gap between the galvanometer mirrors 72a and 72d (or the galvanometer mirrors 92a to 92d) and the magnet 76 (or the magnet 94) can be reduced.

Additionally, in the optical switch 1 according to the first embodiment of the present invention, the common mirror plate 70 (or the mirror plate 90) is etched, thus easily forming the galvanometer mirrors 72a to 72d (or the galvanometer mirrors 92a to 92d) serving as rotatable components simultaneously with the respective supporting members. Mirrors 65 can also be formed with a desired pitch. Thus, small galvanometer mirrors can be formed with low cost.

(Modification of First Embodiment of the Invention)

The present invention is not limited to the structure of the foregoing first embodiment. The number of galvanometer mirrors simultaneously formed in a galvo array or the number of reserved galvanometer mirrors can be appropriately determined in accordance with the number of channels of an optical switch or the yield of the galvanometer mirror.

According to the foregoing first embodiment, the optical switch 1 includes the reserved galvanometer mirrors. When the percentage of non-defective galvanometer mirrors can be lowered, the optical switch can be constructed with no reserve galvanometer mirrors. Therefore, for example, in the optical switch 1 according to the first embodiment of the present invention, the galvanometer mirrors 72a to 72d (or the galvanometer mirrors 92a to 92d) are not used as reserves and all of the galvanometer mirrors 72a to 72d (or the galvanometer mirrors 92a to 92d) are used. Thus, a 4×4 optical switch can be realized.

The number of input/output optical fibers is not limited. A 1×1 ON/OFF switch can also be formed. Additionally, various combinations such as 1×2, 4×1, and 8×8 can also be realized.

According to the above-mentioned first embodiment, the galvanometer mirrors formed by etching silicon are used as the optical-path switching elements. The optical-path switching elements are not limited to this type of galvanometer mirrors. For example, a metal spring is used as a mirror plate, the spring is subjected to insert molding using plastic, and a plurality of glass mirrors are adhered to the molded-plastic, thus forming galvanometer mirrors. In this case, a plurality of galvanometer mirrors can be simultaneously formed and assembled into one unit.

According to the first embodiment of the present invention, the optical switch 1 comprises the three groups of galvanometer mirrors, each group of galvanometer mirrors being arranged in one direction and being able to be tilt in one direction. The optical switch can comprise two groups of galvanometer mirrors which can be tilt in two directions. Various arrangements of galvanometer mirrors and various arrangements of reserve galvanometer mirrors can be used.

In the optical switch 1 according to the first embodiment of the present invention, the coils and magnets are used in the system for driving the galvanometer mirrors 72a to 72d and the galvanometer mirrors 92a to 92d. Electrostatic driving or piezoelectric elements can also be used. In addition to the silicon spring for supporting, a metal spring or link can also be used.

According to the first embodiment of the present invention, the optical switch 1 uses the four PD light receiving surfaces 111a to 111d to detect light through the photo-sensor 11, the surfaces 111a to 111d being formed by dividing the light receiving surface of the photo-sensor 11 into four segments. The arrangement is not limited to the above one. For example, a PSD can also be used. In this case, the central position of light incident on the light receiving surface of the PSD is output as a voltage value.

According to the first embodiment of the present invention, the photo-sensor 11 corresponds to the four galvanometer mirrors arranged in series. The arrangement is not limited to the above one. Two or more galvanometer mirrors can be used. The galvanometer mirrors can also be arranged two-dimensionally.

According to the first embodiment of the present invention, the optical switch 1 includes the angle detector elements constituting the tilt-angle detector unit so as to correspond to the respective galvanometer mirrors. The arrangement is not limited to the above one. For example, the angle detector elements can be removed. In this case, initially, driving currents or voltages for the galvanometer mirrors are stored, the driving currents or voltage corresponding to the predetermined angles of the galvanometer mirrors to be combined as optical paths. Driving currents or voltages are supplied to respective coils of the galvanometer mirrors so that the supplied currents or voltages indicate the stored values. After that, the angles of the galvanometer mirrors can be adjusted using output signals generated from the photo-sensor so that the values of the X and Y axes of light detected through the photo-sensor indicate the optimum values. In this case, since the angle detector elements corresponding to the respective galvanometer mirrors are not needed, the cost and the size of the optical switch can be reduced.

Each galvanometer-mirror angle detector element is constructed as the reflective optical sensor comprising the LED and the PD. A surface emitting laser can also be used instead of the LED. A PSD can also be used instead of the PD.

In addition to the reflective optical sensor, another type sensor such as a capacitance sensor or a magnetic sensor can also be used.

[Second Embodiment]

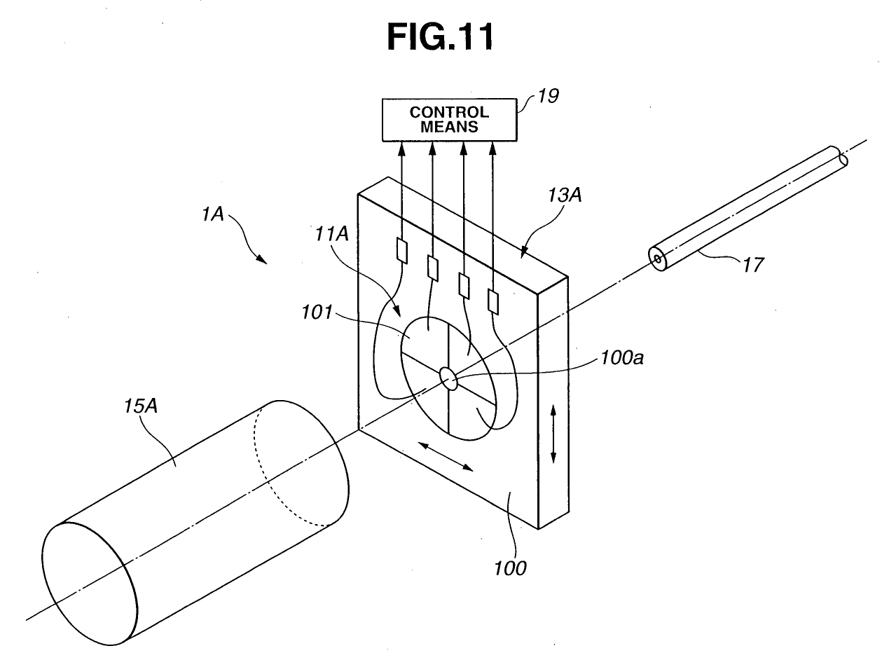

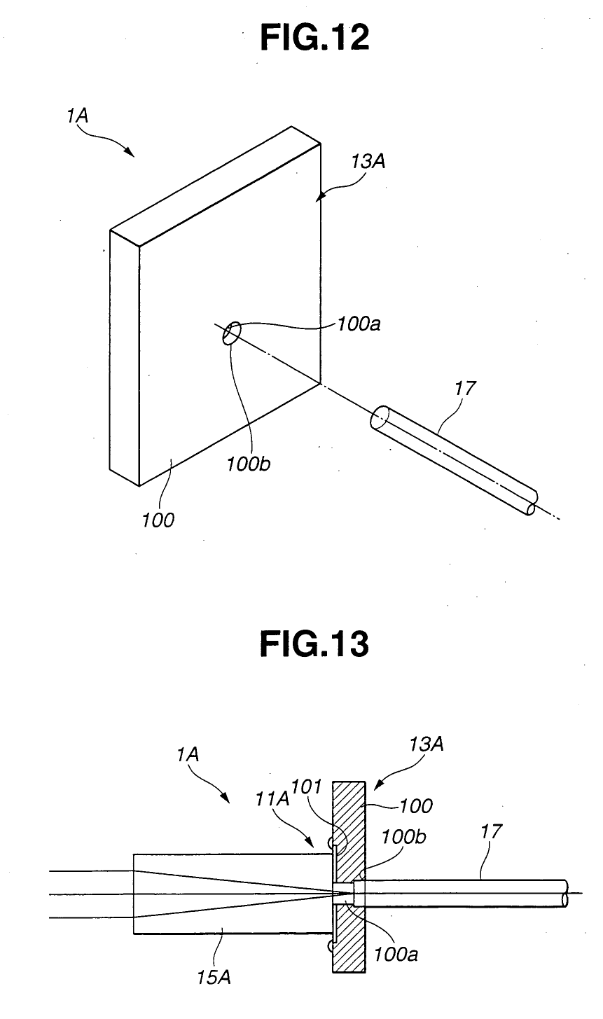

A second embodiment of the present invention will now be described with reference to FIGS. 11 to 13. FIG. 11 is an exploded perspective view of an optical switch according to the second embodiment of the present invention, showing another arrangement of light guiding means and a photo-sensor. FIG. 12 is a perspective view of the optical switch according to the second embodiment of the present invention, showing the relation between the light guiding means, the photo-sensor, and an output optical fiber. FIG. 13 is a side plan view of the optical switch according to the second embodiment of the present invention, the side plan view including a section of the optical switch in which the light guiding means, the photo-sensor, and the output optical fiber are built to each other.

Referring to FIGS. 11 to 13, an optical switch 1A according to the second embodiment of the present invention is different from the optical switch 1 according to the first embodiment with respect to the structure of a portion corresponding to a photo-sensor 11A, light guiding means 13A, and output-side lenses 15A. Since the structure of the other portion is the same as that of the foregoing first embodiment, only the characteristic portion corresponding to one channel is illustrated to give a description.

In the optical switch 1A according to the second embodiment shown in FIGS. 11 to 13, the output-side lens 15A comprises a cylindrical collimating lens of a distributed refractive index type. The light guiding means 13A and the photo-sensor 11A are disposed between the output-side lens 15A and the output optical fiber 17.

The light guiding means 13A comprises a base 100 having a transmission hole 100a through which a beam passes, the beam being reflected by the first galvo unit 9 and then converged through the output-side lens 15A, and the photo-sensor 11A including at least four-divided light receiving elements 101 which are disposed around the transmission hole 100a on the base 100.

The components will be described in more detail. Referring to FIG. 11, the base 100 of the light guiding means 13A comprises an InGaAs base plate and has the transmission hole 100a. Referring to FIG. 12, the rear of the light receiving elements 101 is etched to form an attachment hole 100b for the output optical fiber 17 so that the transmission hole 100a and the attachment hole 100b are concentric.

The photo-sensor 11A is arranged on the base 100 so as to face the output-side lens 15A. The circular light receiving surface of the sensor is divided into four sectors.

Referring to FIG. 13, the output-side lens 15A is positioned on the surfaces of the light receiving elements 101 of the light guiding means 13A and is adhesively fixed thereto. Similarly, the end surface of the output optical fiber 17 is positioned to the attachment hole 100b and is fixed thereto using an adhesive. The photo-sensor 11A partially receives ambient light of a beam condensed through the output-side lens 15A.

When the above-mentioned arrangement is used, the position of a beam on the light receiving elements 101 can be detected on the basis of differential outputs in the X and Y axial directions generated from the four-divided light receiving elements 101.

The output-side lens 15A is positioned on the base 100 with respect to two directions perpendicular to the optical axis and is fixed to the base 100 so that when a reference beam is incident on the output optical fiber 17, the focused reference beam is incident on the core of the output optical fiber 17 to exhibit the maximum intensity of light emitted from the output optical fiber 17. In this instance, detection signals generated from the light receiving elements 101 are input to the control means 19. The control means 19 stores an offset based on differential outputs in the X and Y axial directions as the optimum value.

(Advantages of Second Embodiment of the Invention)

According to the second embodiment of the present invention, the optical switch 1A detects the position of the beam which is condensed through the output-side lens 15A and is close to the entrance end surface of the output optical fiber 17, thus increasing the accuracy of a position detected through the photo-sensor 11A.

In the optical switch 1A according to the second embodiment of the present invention, the light guiding means 13A does not include a beam splitter. The light guiding means 13A is constructed so that the photo-sensor 11A directly detects ambient light of a beam. Thus, advantageously, the difference between the amount of P-polarized light and that of S-polarized light of a light beam for communication is not changed, the transmittance depending on respective wavelengths is not changed, and other undesirable optical influences are not generated.

Further, in the optical switch 1A according to the second embodiment of the present invention, the output-side lens 15A, the light guiding means 13A, and the output optical fiber 17 can be assembled into one unit. Thus, these components can be easily handled. Further, the light receiving elements 101 are disposed between the output-side lens 15A and the optical fiber 17. Thus, the optical switch can be miniaturized.

The output optical fiber 17A can also be adjusted along the optical axis with respect to the attachment hole 100b so that the focal point of light on the output optical fiber 17 is optimized through the output-side lens 15A.

The receiving position of light passing through the output-side lens toward the output optical fiber can be set anywhere so long as the light can be received partially. The form or size of each light receiving element is not restricted. For example, rectangular light receiving elements can be used. The rectangular light receiving elements can partially block and receive a light beam.

[Third Embodiment]

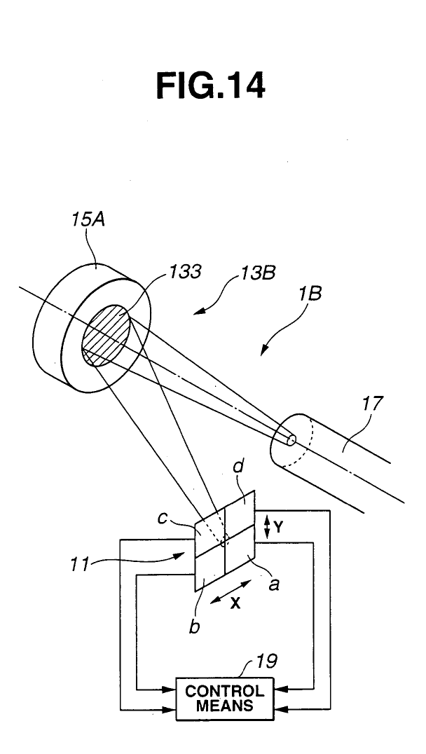

An optical switch 1B according to a third embodiment of the present invention will now be described with reference to FIG. 14. FIG. 14 is a perspective view of the optical switch according to the third embodiment of the present invention, illustrating the relation between an output-side lens, light guiding means, a photo-sensor, and an output optical fiber.

Referring to FIG. 14, the optical switch 1B according to the third embodiment of the present invention is different from the optical switch 1 according to the first embodiment with respect to the position of the photo-sensor 11 and the structure of a portion corresponding to light guiding means 13B and the output-side lens 15A. Since the structure of the other portion is the same as that of the first embodiment, only the characteristic portion corresponding to one channel is illustrated to give a description.

According to the third embodiment of the present invention, the most striking characteristic portion of the optical switch 1B is the light guiding means 13B. In other words, according to the third embodiment of the present invention, the optical switch 1B uses the output-side lens 15A comprising a cylindrical collimating lens of a distributed refractive index type similar to that of the second embodiment. A hologram 133 is formed at one end surface of the output-side lens 15A. Zeroth-order diffracted light of the hologram 133 is allowed to enter the output optical fiber 17. First-order diffracted light is allowed to enter the photo-sensor 11 whose surface is divided into four segments. According to the third embodiment, therefore, the light receiving surface of the photo-sensor 11 is arranged in parallel to the entrance surface of the output optical fiber 17 on which light is incident. Output signals of the photo-sensor 11 are supplied to the control means 19 in the same way as the first embodiment.

(Advantages of Third Embodiment of the Invention)

According to the third embodiment of the present invention, the optical switch 1B does not include a beam splitter functioning as the light guiding means 13 which is the separate component in the optical switch according to the first embodiment. Accordingly, the optical switch can be miniaturized.

The structure of the optical switch according to the present embodiment is not limited to the above-mentioned structure. Instead of the hologram 133, a micro prism or a micro lens can be disposed on the output-side lens to partially split a light beam and polarize the split beam toward the photo-sensor. Further, the hologram or micro prism is not formed on the surface of the output-side lens. The hologram or the like can be formed on another plate.

[Fourth Embodiment]

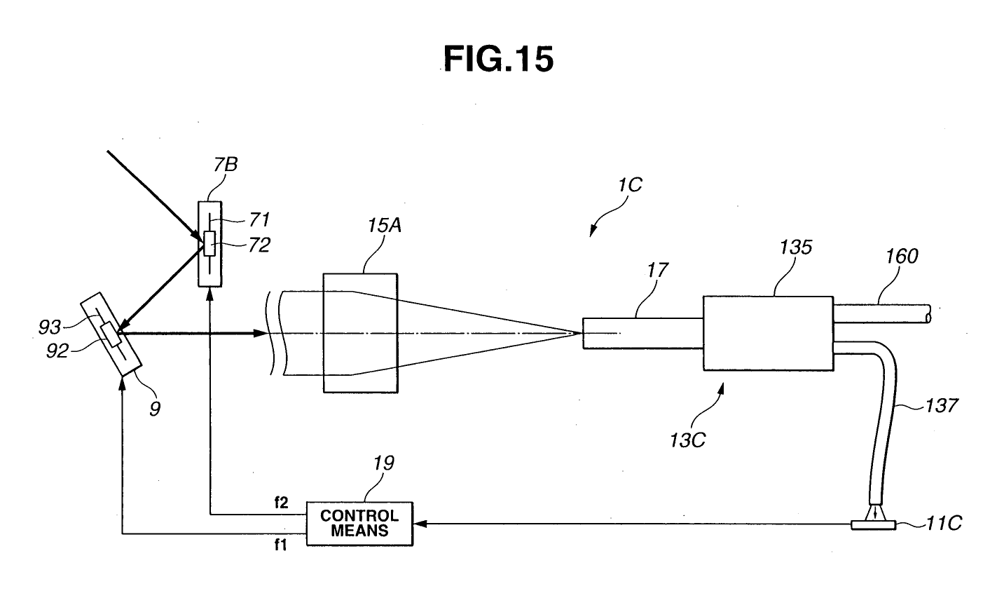

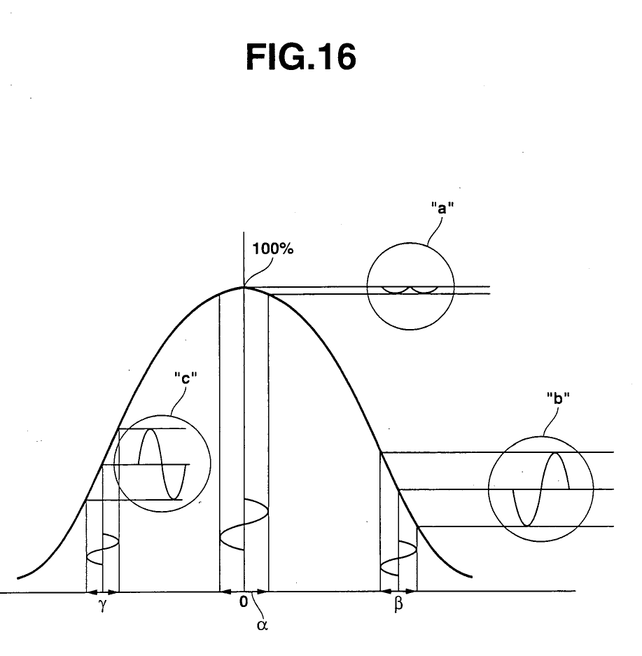

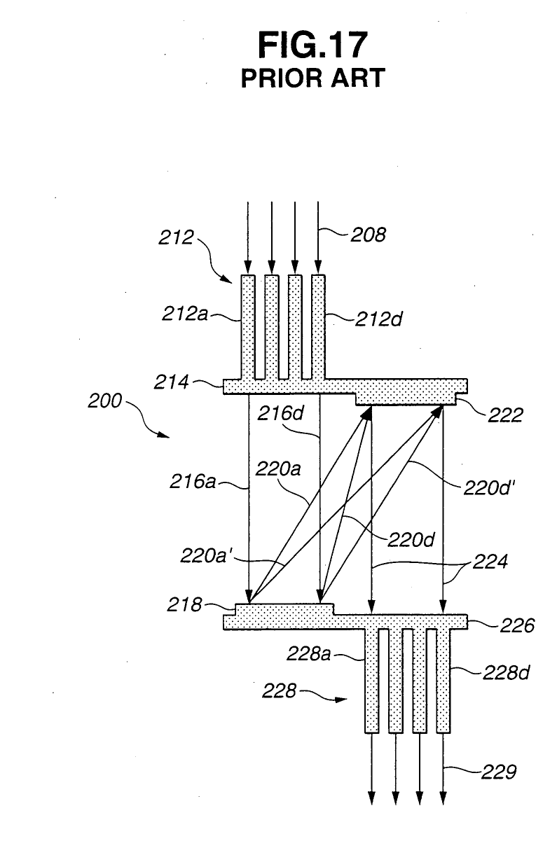

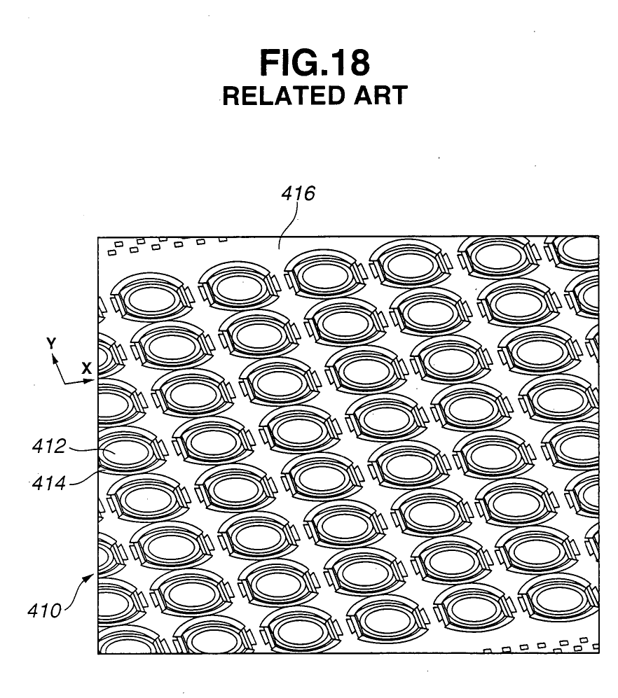

A fourth embodiment of the present invention will now be described with reference to FIGS. 15 and 16. FIG. 15 is a diagram of an optical switch according to the fourth embodiment of the present invention, showing the arrangement of a second galvo unit, a first galvo unit, an output-side lens, an output optical fiber, light guiding means, and a photo-sensor. FIG. 16 is a graph explaining detection signals obtained through the photo-sensor and waveforms thereof in the optical switch according to the fourth embodiment of the present invention. The abscissa axis denotes a position of detected light and the ordinate axis indicates the amplitude of a detection signal.

Referring to FIG. 15, an optical switch 1C according to the fourth embodiment of the present invention is different from the optical switch 1 according to the first embodiment with respect to the structure of a portion corresponding to the output-side lens 15A, the output optical fiber 17, light guiding means 13C, and a photo-sensor 1C. The structure of the other portion is the same as that of the first embodiment. Only the characteristic portion corresponding to one channel is illustrated to give a description.

According to the fourth embodiment of the present invention, the most striking characteristic portion of the optical switch 1C is the light guiding means 13C. The light guiding means 13C partially splits a beam transmitted through the output optical fiber 17 and allows the photo-sensor 11C to receive the split beam. A beam is subjected to small oscillation through the second galvo unit 7B and the first galvo unit 9, thus controlling the angles of mirrors.

In other words, according to the fourth embodiment of the present invention, the light guiding means 13C comprises the output optical fiber 17 capturing a beam which is reflected by the second galvo unit 7B comprising optical-path switching elements and is then reflected by the first galvo unit 9, a photocoupler 135 which is disposed at an output terminal of the output optical fiber 17 and splits a beam into a beam to be detected through the photo-sensor and a beam used for communication, and a sensor fiber 137 for guiding the beam for the photo-sensor to the photo-sensor 1C. Driving signals having respective predetermined frequencies are supplied from the control means 19 to the second galvo unit 7B and the first galvo unit 9, which serve as optical-path selecting means, thus applying small oscillation to the units 7B and 9. Consequently, the amount of light received by the photo-sensor is slightly fluctuated. In this manner, the angles of galvanometer mirrors are controlled so as to obtain the maximum amount of light.

The second galvo unit 7B serving as the optical-path selecting means is oscillated in one direction. The first galvo unit 9 serving as the optical-path selecting means is oscillated in one direction perpendicular to the foregoing one direction. Thus, light reflected by the optical-path selecting means is oscillated small in two directions. The signals, which are supplied from the control means 19 to the second galvo unit 7B and the first galvo unit 9 serving as the optical-path selecting means, have different frequencies to apply small oscillation to light in the two directions.

The optical switch 1C will be described in more detail. According to the fourth embodiment of the present invention, the optical switch 1C uses the output-side lens 15A comprising a cylindrical collimating lens of a distributed refractive index type similar to that of the foregoing second embodiment.

Referring to FIG. 15, in the optical switch 1C according to the fourth embodiment of the present invention, the output optical fiber 17 is disposed in a stage subsequent to the output-side lens 15A. A beam converged through the output-side lens 15A is incident on the core of the output optical fiber 17 on one end surface thereof.

In the optical switch 1C according to the fourth embodiment of the present invention, the photocoupler 135 is disposed on the other terminal of the output optical fiber 17. Due to the actions of the photocoupler 135 and the second galvo unit 7B and the first galvo unit 9 serving as the optical-path selecting means, a light beam for optical communication is partially split and the split beam is guided to the photo-sensor 11C through the sensor fiber 137.

In addition to the sensor fiber 137, a communication fiber 160 through which a beam for communication is transmitted is attached to an output terminal of the photocoupler 135.

The photocoupler 135 appropriately selects the split ratio between light for the sensor fiber 137 and light for the communication fiber 160. For example, the photocoupler 135 splits light into 80 to 98 [%] of light for the communication fiber 160 and 2 to 20 [%] of light for the sensor fiber 137.

Light transmitted through the sensor fiber 137 is incident on the photo-sensor 11C whose surface is not divided. The photo-sensor 11C outputs an output voltage corresponding to the intensity of the incident light and then supplies the voltage to the control means 19.

(Description of Operation)

The operation of the above-mentioned optical switch 1C will now be described with reference to FIGS. 15 and 16.

First, the control means 19 supplies a driving current having a frequency f1 to the coil (shown by reference numeral 95 in the first embodiment) of the first galvo unit 9 to small oscillate the galvanometer mirror 92 about the axis 93. Similarly, the control means 19 supplies a driving current having a frequency f2 to the coil (shown by reference numeral 83 in the first embodiment) of the second galvo unit 7B to small oscillate the galvanometer mirror 72 about the axis 71.

The angle of small oscillation of each of the galvanometer mirrors 92 and 72 is set to, for example, about 1 [mrad] so that a loss of the amount of light incident on the output optical fiber 17 is below an allowed value. The frequency f1 to oscillate the galvanometer mirror 92 is different from the frequency f2 to oscillate the galvanometer mirror 72. These frequencies f1 and f2 are set so that the least common multiple indicates a frequency as large as possible. Specifically, the frequency f1 is set to, for example, 503 [Hz] and the frequency f2 is set to, for instance, 691 [Hz]. The oscillation of the two mirrors allows the light converged through the output-side lens 15A to be oscillated in two directions orthogonal to each other and then enter the output optical fiber 17.

The photocoupler 135 partially splits the light incident on the output optical fiber 17 and then provides the split light to the sensor fiber 137. The light transmitted through the sensor fiber 137 is supplied to the photo-sensor 11C. An output signal of the photo-sensor 11C is input to the control means 19.

The control means 19 has a filter for separating the signal into a signal having an AC component of the frequency f1 and a signal having an AC component of the frequency f2.

In this instance, FIG. 16 shows the relation between the displacement on the output optical fiber 17 by the light focused on the end surface of the output optical fiber 17 through the output-side lens 15A, and the amount of light incident on the core of the output optical fiber 17. In other words, when the focal point of light converged through the output-side lens 15A is located on the center of the core of the output optical fiber 17, the maximum amount of light is obtained.

When the focal point is located at the center (point α) of the core as shown in FIG. 16, an output of the photo-sensor 11C, obtained by small oscillating the galvanometer mirrors 72 and 92, indicates a single-amplitude waveform having a small amplitude (half-wave rectified waveform) as shown by reference symbol “a”.

When the focal point is deviated from the point a to, for example, a point β shown in the right-hand part in FIG. 16, the output of the photo-sensor 11C indicates a dual-amplitude waveform having a large amplitude as shown by reference symbol “b”. When the focal point is deviated from the point α to, for example, a point γ in the left-hand part in FIG. 16, the output indicates a dual-amplitude waveform having a large amplitude as shown by reference symbol “c”, the phase of the waveform being inverted from that of the waveform shown by reference symbol “b”.

As mentioned above, whether the focal point of light converged through the output-side lens 15A is deviated from the core of the output optical fiber 17 and the direction of displacement can be found using the output waveform of the photo-sensor 11C.

Therefore, a detection signal of the photo-sensor 11C is supplied to the control means 19, the control means 19 detects the amplitude and phase of the output waveform of the photo-sensor 11C, and the control means 19 tilts the galvanometer mirrors 72 of the second galvo units 7A and 7B and the galvanometer mirror 92 of the first galvo unit 9, thus controlling the movement of the focal point of light converged through the output-side lens 15A toward the center of the core of the output optical fiber 17.

The oscillation frequency for the galvanometer mirror 72 is different from that for the galvanometer mirror 92. Therefore, when only the amount of light transmitted through the fiber is detected, the displacement of light incident on the output-side fiber 160 in the two directions can be detected. As mentioned above, the amount of light passing through the output-side fiber 160 can be directly controlled to the maximum amount.

(Advantages of Fourth Embodiment of the Invention)

In the above structure, the detection of inclination of mirrors and the detection of the position and inclination of light can be omitted in the galvanometer mirror units.

(Modification of Fourth Embodiment of the Invention)

In the optical switch 1C according to the present embodiment of the present invention, light is oscillated in two directions. Light can also be oscillated in one direction.

The frequencies to oscillate light in two directions are different from each other. Instead of continuous sinusoidal oscillation, discontinuous sinusoidal oscillation can be performed so that the oscillations in two directions are staggered.

When two-axial galvanometer mirrors which can be tilt in two directions are used, each galvanometer mirror can be oscillated in two directions.

[Modification]

In the above respective embodiments of the present invention, the galvanometer mirrors which can be tilt are used as the optical-path switching elements. In addition, a structure in which the combination of facing optical fibers can be switched to another one as disclosed in Japanese Unexamined Patent Application Publication No. 2001-21818, a structure in which a prism is shifted as disclosed in Japanese Unexamined Patent Application Publication No. 2001-272612, and other structures can also be applied.

As mentioned above, the optical switches described in the above embodiments of the present invention have the following advantages.

(1) Transmitted light for optical communication is detected. The optical-path switching elements are adjusted using the detection result. Consequently, the adjustment accuracy is fine and a loss of the amount of light in the optical switch can be reduced.

(2) The optical-path switching elements can be adjusted without disposing a special sensor for detecting the positions of the optical-path switching elements. Thus, the structure can be simplified.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. An optical switch comprising:
optical-path switching elements for switching one optical path to another optical path in order to allow one light beam for optical communication emitted from one input optical fiber used for inputting beams out of one or a plurality of input optical fibers, to be incident on one output optical fiber from which beams are outputted out of one or a plurality of output optical fibers;
a photo-sensor;
light guiding means for guiding the beam to be incident on the output optical fiber to the photo-sensor; and
control means for controlling the angle of the optical-path switching element on the basis of detection signal obtained through the photo-sensor.

2. The optical switch according to claim 1, wherein the optical-path switching element includes a galvanometer mirror.

3. The optical switch according to claim 1, wherein the light guiding means is constructed so as to guide a light beam transmitted through at least one optical-path switching element to the photo-sensor.

4. The optical switch according to claim 3, wherein the light guiding means is constructed so as to split a light beam transmitted through at least one optical-path switching element using a beam splitter and then guide the split beam to the photo-sensor.

5. The optical switch according to claim 3, wherein the light guiding means includes the photo-sensor comprising a base having a hole through which a light beam passes, the beam being transmitted through at least one optical-path switching element, and at least two or more light receiving elements disposed around the hole on the base.

6. The optical switch according to claim 1, wherein the light guiding means is constructed so as to partially split a light beam transmitted through the output optical fiber and allow the photo-sensor to receive the split beam.

7. The optical switch according to claim 6, wherein
the light guiding means comprises: an output optical fiber for capturing a light beam transmitted through at least one optical-path switching element; a photocoupler which is disposed on an output terminal of the output optical fiber and which splits the beam into a beam for the photo-sensor and a beam for communication; and a sensor fiber for guiding the split beam for a fiber used for the photo-sensor to the photo-sensor, and
each optical-path switching element is constructed so as to be oscillated small when a driving signal with a predetermined frequency is supplied thereto.

8. The optical switch according to claim 7, wherein each optical-path switching element is constructed so as to be oscillated small in two directions.

9. The optical switch according to claim 8, wherein driving signals to be supplied to each optical-path switching element have different frequencies so that the element is oscillated small in the two directions.

10. An optical switch comprising:
optical-path switching elements for switching at least one optical path to another optical path in order to allow one light beam for optical communication emitted from one input optical fiber used for inputting beams out of one or a plurality of input optical fibers, to be incident on one output optical fiber from which beams are outputted out of one or a plurality of output optical fibers;
a photo-sensor;
light guiding means for guiding the beam to be incident on the output optical fiber to the photo-sensor; and
control means for adjusting the angle of the optical-path switching element on the basis of detection signal obtained through the photo-sensor to adjust at least one of the relative position and the angle of the beam.
